(19) United States
(12) Patent Application Publication
(10) Pub. No.: US 2023/0320815 A1
(43) Pub. Date: Oct. 12, 2023

(54) ENDODONTIC FILES WITH HYBRID METALLURGICAL ELASTIC CHARACTERISTICS AND IDENTIFICATION COLORS

(71) Applicant: Pac-Dent, Inc., Brea, CA (US)

(72) Inventors: Carlos Alberto Spironelli Ramos, Henderson, NV (US); Emmanuel Joao Nogueira Leal da Silva, Niterio (BR); Daniel Wang, Brea, CA (US); Robert Yue, Suzhou (CN)

(73) Assignee: Pac-Dent, Inc., Brea, CA (US)

(21) Appl. No.: 17/719,301

(22) Filed: Apr. 12, 2022

(51) Int. Cl. A61C 5/42; B24B 19/02

(52) U.S. Cl. CPC A61C 5/42; B24B 19/022

(57) ABSTRACT

The invention describes an additional manufacturing method to improve the metallurgical properties of an endodontic file, which method customizes torsional and cyclic fatigue resistance behavior performance for separate files sizes. A heat-treatment file size tailored method accomplished after grinding the blank is disclosed aiming to improve the elasticity behavior of the specific file size based on its application during instrumentation protocol, also generating a colored oxidation layer on the working part surface of the file. The colored coded customized heat-treatment process will help the operator to identify the improved metallurgical properties behavior of each file, and decide the best use of such files.

### BACKGROUND OF THE INVENTION

### Field of the Invention

The present invention is related to an endodontic mechanical instrumentation procedure, and more particularly directed to a method for manufacturing an endodontic file, and specifically to an engine-driven endodontic file.

### Background Information

Root canal instrumentation is accomplished by the use of endodontic instruments and irrigating solutions under aseptic working conditions. Root canal instrumentation may be carried out using hand-held or engine-driven instruments. Up until the last decade of the past century, endodontic instruments were manufactured out of stainless-steel. Stainless-steel files have an inherent stiffness that increases as the instrument size increases. As a result, when preparing a curved root canal, restoring forces attempt to return the instrument to its original shape, especially when the operator uses a filing motion. Therefore, in curved canals, steel instruments must be pre-curved for use, which effectively prevents them from being used in a rotary motion. An instrument that is too stiff will cut more on the convex (outer) side than on the concave (inner) side, thereby straightening the curve.

Engine-driven files manufactured out of a nickel-titanium (NiTi) alloy have proven to be a valuable adjunct for root canal therapy. NiTi instruments are highly flexible and elastic. Advantageously, NiTi rotary shaping files have nearly eliminated the iatrogenic instrumentation complications that are often connected to endodontic steel instruments. NiTi instruments were introduced over two decades ago. Since their first appearance, instrument design has changed considerably; progress has been made in manufacturing as well as alloy heat-treatment. Traditionally files had been produced according to empiric designs, and even today many instruments are still devised by individual clinicians rather than developed through an evidence-based approach. Clinical procedures and ideal working parameters are still being refined as new instruments continue to be introduced to the market. With new versions rapidly becoming available, the clinician may find it difficult to choose the file and technique most suitable for an individual case or even during one case instrumentation protocol. NiTi instruments have undergone a revolution regarding different designs to produce an instrument that cuts effectively while exhibiting resistance to fracture even in the most challenging anatomical confines. One should always bear in mind that all file systems have benefits and weaknesses. Instrument properties are derived from the type of alloy, degree of taper, cross-sectional design and heat-treatment protocol.

Nickel-titanium (NiTi) alloy has been used in endodontics for almost 30 years and has brought a major breakthrough to root canal therapy. NiTi endodontic instruments with super-elasticity have gained extensive popularity amongst clinicians due to their higher flexibility and greater torsional resistance than the traditional stainless-steel ones. Therefore, an increasing number of super-elastic NiTi endodontic files with various geometry designs (cross-sectional shape with or without “radial lands” or sharp cutting edges, constant or variable pitch, and progressive or constant taper) have been developed. However, the undesirable and unexpected separation of NiTi endodontic rotary files during root canal instrumentation caused by flexural (cyclic) fatigue and/or torsional overload still remains a serious concern and drawback in clinical use. Torsion overload is one of the primary mechanisms responsible for the intracanal separation of NiTi endodontic instruments, which accounts for 55.7% of the failures of NiTi rotary files. It can be generated within the rotary file when the tip or some part of the instrument is locked against the canal wall while the shank of the file (driven by the handpiece) continues to rotate or is subjected to excessive pressure by the operator. The tip fractures when the handpiece torque exceeds the ultimate strength of the metal. High torsional stiffness is desirable for the clinical performance of small sizes of rotary files owing to the enhanced cutting efficiency and reduced torsional failure risk. Cyclic fatigue occurs when a metal is subjected to repeated cycles of tension and compression that cause its structure to break down, ultimately leading to fracture. It is the main reason for the majority of broken instruments. The fracture caused by cyclic fatigue of NiTi endodontic instruments is difficult to detect during clinical practice due to the invisible signs of permanent deformation during cyclic fatigue. That is why many attempts have been made to improve the resistance to cyclic fatigue for NiTi files, predominantly novel heat-treatment protocols.

In recent years, novel kinds of NiTi endodontic files fabricated by proprietary heat-treatment processes are being propose to mitigate file breakage during its clinical use. In this case, normally the heat-treatment gives more flexibility to the file, increasing cyclic fatigue resistance. This particular feature is adequate for larger sizes of the files since they have more metal mass. If the same method is accomplished in small files sizes, a side effect can occur leading the file to unwinding when some pressure is undergoing.

NiTi endodontic files used in clinical practice are subjected to both flexural fatigue and torsional load simultaneously during root canal preparation procedures, probably leading to instrument separation due to hybrid forces. Bending is imposed by the root canal anatomy, in the case of blockage, it is also associated with torsion. Clinically, both cyclic fatigue and torsional failure probably occur simultaneously. The mechanical properties of NiTi endodontic instruments including flexibility, torsional resistance, and flexural fatigue are fundamental requirements of endodontic instruments for successful use. The flexibility is beneficial for maintaining the original shape of root canals, especially for the ones with severe curvatures. Adequate torsional resistance and flexural fatigue resistance favor reducing the occurrence of file breakage. Thus, flexibility and resistance to fracture constitute properties expected for an ideal root canal file.

From a material point of view, the properties of NiTi alloys depend on their chemical composition, phase constitution, and fabrication procedures, among which the metallurgical properties including the chemical composition and phase constitution are the internal factors and the fabrication procedures such as cold working, heat-treatment before and/or after grinding the blank are the factors that can determine mechanical properties for NiTi endodontic files. Controlling mechanical properties and their association with the metallurgical properties of NiTi rotary instruments is helpful for clinicians to make decisions regarding which instruments are appropriate for each phase of the instrumentation procedures of root canal therapy. The influence of metallurgical properties on endodontic files mechanical properties is possible to be adjusted to each file size by controlling the heat-treatment for each specific file on the instrumentation sequence. In this sense, tailoring the heat-treatment for each file size can keep flexibility to larger files while maintain torsional resistance to small size files.

NiTi alloy can exist in two different temperature-dependent crystal structures called martensite (lower temperature or daughter phase) and austenite (higher temperature or parent phase). The crystal lattice structure can be altered by either temperature or stress. This is important because several properties of the two forms are notably different. Near equiatomic NiTi alloys contain three microstructural phases (i.e., austenite, martensite, and R-phase), the character and relative proportions of which determine the mechanical properties of the metal. When the material is in its martensite form, it is soft and ductile and can easily be deformed, while austenitic NiTi is quite strong and hard. The conventional super-elastic NiTi file has an austenite structure at room and body temperatures. It is well known that the nature of the alloy and the manufacturing process greatly affect the mechanical behavior of the instrument. To improve the fracture resistance of NiTi files, new alloys were introduced to manufacture NiTi files or developed new manufacturing processes. A series of proprietary thermomechanical processing procedures has been developed with the objective of producing super-elastic NiTi wire blanks that contain the substantially stable martensite phase under clinical conditions. Enhancements in these areas of material management have led to the development of the new generation of endodontic NiTi instruments. NiTi files with heat-treated process contain a mixture of austenite and martensite conditions at body temperature. The martensitic phase of NiTi has some unique properties that have made it an ideal material for many applications. The martensitic phase transformation has excellent damping characteristics because of the energy absorption characteristics of its twinned phase structure. In addition, the martensitic form of NiTi has an excellent fatigue resistance.

Therefore, endodontic files with high expression of austenitic phase will have more torsional fatigue resistance, while files with high expression of martensitic phase will have a better cyclic (flexure) fatigue resistance. If the same heat-treatment is performed for all sizes, some of them will benefit of the accomplished metallurgical changes while others will be harmed. One method doesn't equally benefit all sizes needs and it is imperative that customize heat-treatment protocols be applied so that all files sizes are adequately improved in its mechanical behavior.

U.S. Pat. No. 4,889,487 discusses an endodontic file having one or more elongated, bow-shaped bends for being used to enlarge and shape the root canal. Since not all root canals have the same geometry, a conventional tapered file typically produces a circular cross-section thereby limiting the removing the dentin and soft tissue from the canal to generally one sized canal opening corresponding to the circular-cross-section of the conventional file. This patent discusses crimping the file between to stamping member to shape the file to the desired bend radius. The problem with crimping a file is that the tool used to crimp may potentially damage the fluting of the file thus making it less efficient in cutting. Another issue with crimping a file is that it inherently weakens the file in that crimped area thus making it more susceptible to breaking within the canal.

US 2010/0233648 A1 discloses a method of manufacturing an endodontic file. A rod of superelastic material is set into a shaped configuration to form an instrument, such that the instrument may be inserted into a root canal in a configuration different than the shaped configuration and revert towards its shaped configuration during the endodontic procedure. This invention is related with an asymmetric shape file that is manufactured by using a specific heat treatment to keep the final desired shape of the lamina. Asymmetric files are difficult to control inside the canal, especially in regarding of working length control. It is impossible to predict the elongation of the asymmetric file inside the canal, and how far this deformation can impact on the apical tissues.

U.S. Pat. No. 10,716,645 B2 discloses a variable-heat treatment that is applied to a file blank based on the total material mass of the desired file. One problem of this patent is how accurate is the final metal mass prediction and how the possible difference between prediction and achieved metal mass can impact on the proposed heat treatment. Furthermore, the aforementioned invention is not clear if the file will be made by twisting the heat treated blank or grinding. Additionally, U.S. Pat. No. 10,716,645 B2 does not mention any color code related to cyclic fatigue or torsional fatigue resistance.

### SUMMARY OF THE INVENTION

The present invention seeks to improve metallurgical properties of endodontic files by providing an enhanced process of manufacturing tailored for each size of file. The present invention provides an additional method on the manufacturing of endodontic files that grants customized balance of austenitic phase (also call super-elasticity) and martensitic phase (also call controlled memory), providing enhanced metallurgical properties for the different sizes of the file. Thus, different files sizes will present suitable torsional and flexural fatigue resistance based on the size and application of the specific file on the instrumentation phase (i.e., coronal shaping, glide-path, finishing apical preparation). The present invention also describes the method for identifying the customized heat-treatment and the desired properties (more austenitic phase or more martensitic phase) by colors generated during each heat-treatment protocol suggested. By increasing one or the other aforementioned metallurgical phases, the endodontic file behavior tends to be more resistant to torsional or flexural (cyclic) fatigue, helping to avoid the undesirable file breakage during the procedure.

Super-elastic (austenite phase predominant) materials are typically metal alloys which return to their original shape after substantial deformation. Super-elasticity may be generally defined as a complete rebound to the original position after deformation. Super-elastic alloys such as nickel titanium (NiTi) or otherwise can withstand several times more strain than conventional materials, such as stainless steel, without becoming plastically deformed. Controlled-memory alloys (martensite phase predominant) in a non-super-elastic martensitic state. The non-super-elastic file may provide more flexibility and increased fatigue resistance through an optimized microstructure while effectively shaping and cleaning root canals.

Files having pre-determined percentages of austenite phase and martensite phase exhibit higher resistance to cyclic fatigue and torsional stress when operating in the canal. Producing smaller files with more shape memory to prevent unwinding and larger files with remarkable ductility are the milestones of an ideal customized heat-treatment.

Heat-treatments of NiTi in air, argon and partially reduced atmosphere have been explored. Temperatures about 350° C. to about 550° C. interval are used to design optimal super-elasticity and controlled memory shape, and for shape setting procedure. Thus, after heat-treatment in controlled environment at 350° C. to about 550° C. for a period of time from about 5 minutes to about 120 minutes, and cooling under controlled environment, oxidation producing TiO, pure Ni and NiTi in B2 phase are detected in external surface layers. After oxidation, different phases are observed: TiO₂, Ni and Ni₃Ti. Beneath the Ni-rich Ni₃Ti layer, the austenitic and martensitic NiTi phase are present simultaneously implying an alteration of shape recovery temperatures of the metal adjacent to the interface. When the oxidation proceeds further and the thickness of the oxidation layer increases, different colors based on the concentration of the different oxidation elements will be present at the external surface of the metal. Different heat-treatment protocols will provoke different oxidation layer thickness and oxidation state of the oxygen layer, leading to different whole working file part color and color shade (primarily purple, blue and gold). Depending on the heat-treatment protocol applied (based on the file size primarily), one of the aforementioned colors will be present, helping to identify the type of more predominant phase that file is presenting after the customized heat-treatment. These colors will be prevalent in the whole working part of the instrument when the heat-treatment is applied after grinding and will help the operator identify the suitable file to the procedure phase.

Normally, the heat-treatment process can be performed prior and/or after grinding a file blank. Heat-treatment (also called annealing) refers to heating an alloy to a threshold temperature and maintaining that temperature for a time sufficient to bring about a desired change in a property of the alloy. In embodiments, the heat-treatment is done after the grinding process. Thus, the file shape, cross-section and size will be supplemented with the right mechanical properties for that specific file size achieved by the equivalent heat-treatment protocol.

Heat-treatment process for a grinded file blank includes heating the file at a threshold temperature and for a sufficient time to bring the desired crystal structure between 100% austenite and 100% martensite. The heat-treatment may be performed by a conventional heating oven, electrical heating, or inductance heating.

The present invention seeks to improve the properties of the endodontic files by specific heat-treatment after grinding the blank of each size of the file. Fundamentally applying a customized heat-treatment protocol process to a grinded blank provides smaller size files that will maintain torsional stress resistance, and delivers larger size files with increased cyclic fatigue resistance. Heat-treatment techniques provide an endodontic file with a crystal structure that is best suited to the desired geometric parameters and/or desired performance characteristics of the specific file size. The ratio of deformation/force to deform the endodontic file will be determined by the specific size of each instrument.

One advantage of the present invention is that it introduces a heat treatment process that adds for each specific file size more resistance to torsional and cyclic fatigue in an accurate approach.

Another advantage of the present invention is providing a method for forming a non-super-elastic file customized for each file step during the instrumentation sequence with different proportions of martensitic/austenitic phases, easily recognizable by the colors of the working part achieved during the described heat treatment process.

Another advantage of the present invention is to use the final shaped (size, cross-section, tip design) grinded blank (instead of non-grinded blank) to perform a customized heat-treatment. Therefore, the heat-treatment tailored for that specific size will accurately fulfill its purpose and create a unique colored oxidation layer that will identify the mechanical behavior of the file.

Thus, methods for a customized heat-treatment aiming to produce hybrid austenite/martensite phases endodontic file sizes have been provided.

In embodiments, a set of hybrid austenite/martensite NiTi endodontic files is disclosed, where for each file size in the set a customize heat-treatment is applied to each file after grinding a blank, which files in the set exhibit different levels of flexibility and torsional resistance depending on the sizes and exhibited colors of the resulting files, where the set is optionally configured to attach to an engine/motor driven device.

In one aspect, the exhibited colors are selected from purple, blue or gold. In a related aspect, the exhibited colors correspond to different levels of cyclic (flexural) fatigue resistance and/or torsional fatigue resistance. In a further related aspect, the levels of cyclic (flexural) fatigue resistance further depend on the size of the file. In still another related aspect, the levels of torsional fatigue resistance further depend on the size of the file.

In another aspect, the colors and colors shades of the entire work part are purple, blue or gold.

In one aspect, the heat treatment comprises multiple variable heat-treatment techniques that decrease the percentage of superelasticity to control memory within a file as file size increases.

In another aspect, the heat treatment is applied after grinding the blank based on the final dimensions of the file.

In embodiments, a method of manufacturing a set of austenite/martensite NiTi endodontic files is disclosed, including grinding one or more NiTi wires; optionally shaping the one or more NiTi wires into a blade; optionally grinding the proximal and distal tips of the bladed one or more NiTi wires; cleaning the ground bladed one or more NiTi wires by ultrasonication; heating the sonicated one or more NiTi wires; cooling said heated one or more NiTi wires; and assembling an endodontic file from the cooled one or more NiTi wires, where the endodontic file includes a handle, smooth shaft and blade.

In one aspect, the one or more NiTi wires have different diameters.

In another aspect, the diameters are selected from the group consisting of about 0.8 mm, about 1.0 mm, and about 1.2 mm. In one aspect, the smooth shaft contains one or more measuring lines.

In one aspect, the one or more sonicated NiTi wires are heated to between about 350° C. to about 550° C.

In another aspect, the one or more sonicated NiTi wires are heated for between about 5 minutes to about 120 minutes, where sufficient oxidation occurs producing TiO, pure Ni and NiTi in a B2 phase on an external surface layer, and where, after oxidation, different phases are observed comprising TiO₂, Ni and Ni₃Ti beneath the Ni-rich Ni₃Ti layer.

In embodiments, a method of manufacturing a set of austenite/martensite NiTi endodontic files is disclosed, including grinding one or more NiTi wires; shaping the one or more NiTi wires into a blade; grinding the proximal and distal tips of the bladed one or more NiTi wires; cleaning the ground bladed one or more NiTi wires by ultrasonication; heating the sonicated one or more NiTi wires to between about 350° C. to about 550° C. for a time sufficient to produce TiO, pure Ni and NiTi in a B2 phase on an external surface layer; cooling the heated one or more NiTi wires; and assembling an endodontic file from the cooled one or more NiTi wires, where the endodontic file includes a handle, smooth shaft and blade.

An endodontic device made by the above methods, where the exhibited colors are selected from purple, blue or gold.

### BRIEF DESCRIPTION OF THE DRAWINGS

FIGS. 1, 2 and 3 illustrates different heat-treatments during endodontic manufacturing presented by this invention.

FIG. 1 shows a photograph of active part, including tip and penetration guide of three (3) endodontic files resulting from heat-treatments as disclosed herein: gold (top file), blue (middle file) and purple (bottom file).

FIG. 2 shows a photograph of the measuring lines, including tops of handles with color guide, of three (3) endodontic files resulting from heat-treatments disclosed herein: gold (top file), blue (middle file) and purple (bottom file).

FIG. 3 shows a photograph of active part, including tip and penetration guide and measuring lines of three (3) endodontic files resulting from heat-treatments disclosed herein: gold (top file), blue (middle file) and purple (bottom file).

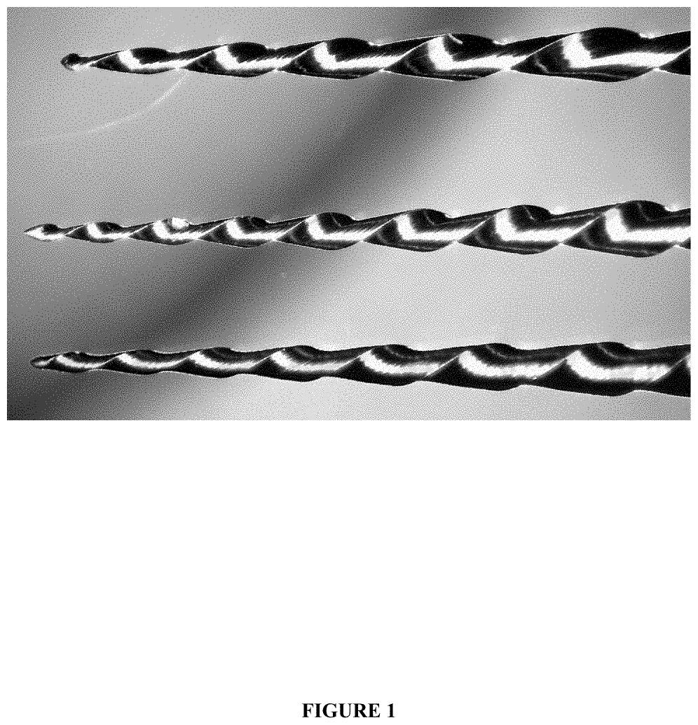

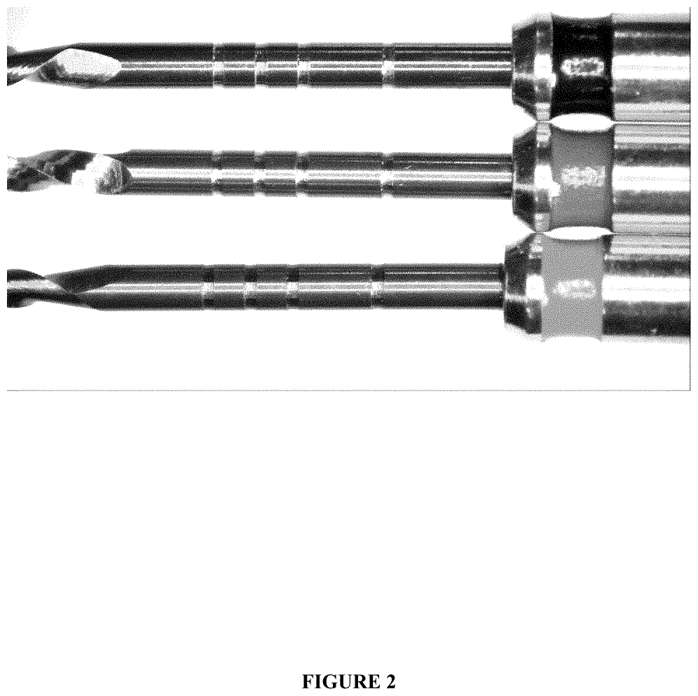

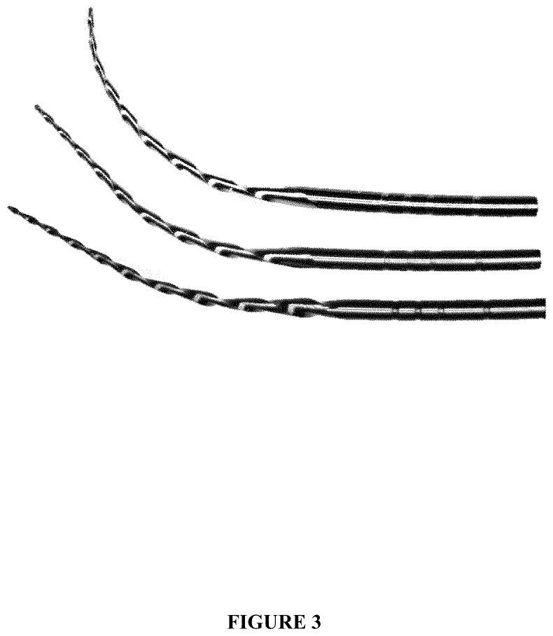

### DETAILED DESCRIPTION OF THE INVENTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a,” “an,” and “the” include plural references unless the context clearly dictates otherwise. Thus, for example, references to “a wire” includes one or more wires, and/or compositions of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

As used herein, “about,” “approximately,” “substantially” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term and “substantially” and “significantly” will mean plus or minus >10% of the particular term. In embodiments, a composition may “contain,” “comprise” or “consist essentially of” a particular component or group of components, where the skilled artisan would understand the latter to mean the scope of the claim is limited to the specified materials or steps “and those that do not materially affect the basic and novel characteristic(s)” of the claimed invention.

As used herein, “superelasticity” means an elastic (reversible) response to an applied stress, caused by a phase transformation between the austenitic and martensitic phases of a crystal.

As used herein, “endodontic file” and “endodontic device” are surgical instruments used by dentists when performing root canal treatment.

As used herein, “cyclic fatigue” means the stress, strain, and deformation induced in a material by cyclic loading.

As used herein, “torsional fatigue” means a fracture in a shaft caused by a proximal end of a shaft bound to one surface where mechanical stress is applied perpendicular to the long axis of said shaft at its distal end.

As used herein, “an engine/motor driven device” means a hand-held or mounted, mechanical instrument used to perform a variety of dental procedures (e.g., including removing decay, polishing fillings, performing cosmetic dentistry, and altering prostheses), which device may be air driven or motor driven, cordless or non-cordless.

As used herein, “controlled memory” refers to the property of an alloy that can be deformed when cold but returns to its pre-deformed (“remembered”) shape when heated.

In embodiments, raw materials are prepared, including NiTi wires (e.g., with different diameters: about 0.8 mm, about 1.0 mm and about 1.2 mm), handle, ink, stopper and package materials to make the endodontic device using a customized CNC grinder and appropriate NiTi wire to grind the flutes of the file, where to each file a particular program is applied. After grinding the flutes, the NiTi wire is turned into a blade, where the distal and proximal tip of the blade are subjected to grinding, the blade may be cleaned by ultrasonic cleaner (although other means of cleaning would be clear to the skilled artisan); where the blade is heat treated based on the operating requirement, e.g., different file and different colors, subjected to different heat treatment parameters, such as the temperature, duration and cooling period.

Existing endodontic files typically include two or more cutting edges.

A working length of a file has helical or non-helical flutes that include cutting edges. The working length is located between a proximal (shank) and distal (tip) end of a file. Endodontic files typically include two or more flutes. Generally, each flute has two cutting edges—a cutting edge and a trailing edge. A file having a triangular cross-section has three flutes and six theoretical edges. However, due to the triangular shape of the cross-section, the trailing edge of flute 1 is also the cutting edge of the flute 2, the trailing edge of the flute 2 is also the cutting edge of the flute 3, and the trailing edge of flute 3 is also the cutting edge of flute 1. Therefore, the triangular file typically has three cutting edges.

A geometric parameter of an endodontic file includes dimensions of the file's tip. The tip provides two main functions: a) the tip enlarges the canal during shaping and b) guides the file through the canal during shaping.

These two functions of the tip are accomplished by balancing various geometric parameters of the tip. Illustrative geometric parameters include the rake angle of the cutting edge, angle and radius of the tip's cutting edge and proximity of a flute end to the tip end of the file. Balancing such geometric parameters of endodontic files has not been easily achieved. For example, typically, in existing files, improved tip functionality may come at the expense of other performance characteristics of the file.

Flutes, taper, tip or any other geometric parameter of an endodontic file may be fabricated by twisting a file blank having a triangular, square, or rhomboid-shaped cross section. Another method for fabricating helical or non-helical flutes, taper, tip or other geometric parameters includes a machining process. For example, a solid file blank is moved past a rotating grinding wheel. The file blank is repeatedly indexed and moved past the grinding wheel as many times as necessary to form a file having the desired geometric parameters.

In embodiments, a file is manufactured by grinding a tube/shaft/cylinder, as the case may be.

A performance characteristic of an endodontic file may be obtained by applying a heat treatment. An illustrative heat treatment may include an annealing process. The annealing process is performed prior to forming a file blank, or performed on the blank after its formation. Annealing refers to heating an alloy to a threshold temperature and maintaining that temperature for a time sufficient to bring about a desired change in a property of the alloy.

For example, an annealing process for a NiTi file blank includes heating the blank at a threshold temperature and for a sufficient time to bring the blank to a state having a desired crystal structure between 100% austenite and 100% martensite. The crystal structure preferably includes a percentage of rhombohedral phase crystal structure. In embodiments, the rhombohedral phase is the only crystal structure. Alternatively, the crystal structure is a combination of austenite and martensite without any rhombohedral phase. In one aspect, NiTi ratios may be 56 wt % nickel and 44 wt % titanium.

A threshold temperature for inducing the desired crystalline structure may be dependent upon a particular NiTi alloy, but generally is in the range of about 250-359° C. for typical NiTi alloys, and is advantageously in the range of about 350-550° C. In one aspect, for 0.8 mm files, heat-treatment may be in the range of between about 400-450° C., for 1.0 mm/1.2 mm files, heat-treatment may be between 450-550° C. In one aspect, cooling temperatures may be as follows: for gold, between about 350-400° C., for purple between about 400-450° C., for blue between about 450-550° C. Generally, annealing time for a NiTi file blank ranges from about 5 minutes to about 120 minutes, about 30 minutes to about 60 minutes, 60 minutes to about 120 minutes, or 120 minutes.

Following an annealing process, a file blank may be cooled to room or ambient temperature, upon which it retains the desired crystal structure. After annealing, the instrument blank includes a superelastic material in a rhombohedral phase alone or in combination with austenite and/or martensite, or in a phase structure that is a combination of austenite and martensite.

After the annealing process, cutting edges are fabricated in the file blank. For example, the file blank may be twisted at low temperature (e.g., less than about 100° C.). The twisting may be performed at ambient temperature, without immersing the blank and tooling equipment into high temperature salt baths or exposing them to other high temperature methods.

Cooling may be performed by any suitable methods. For example, the heated file blanks may be cooled by placing the heated file blank in an environment at room temperature and waiting for the files to cool for a certain period of time. In embodiments, cooling critical time is between about 120 min-180 min, depending on the file size.

Illustrative heat-treat methods and apparatus are in U.S. Pat. No. 7,779,542, which is incorporated by reference herein in its entirety.

### EXAMPLES

Table 1 shows examples of properties of treated blanks as described herein.

| | | | Temp/Temp | | |
|---|---|---|---|---|---|
| | | | Range | | Property |
| | Temp/Temp | | (Reacts | | (CF or TF |
| Size | Range | Time | with O₂) | Color | resistance) |
| 0.8 mm | 400-450° C. | 5 min- | 400-450° C. | purple | CF/TF |
| | | 60 min | | | |
| 1.0 mm | 450-550° C. | 60 min- | 450-550° C. | blue | TF |
| | | 120 min | 400-450° C. | purple | TF |
| | | | 350-400° C. | gold | CF |
| 1.2 mm | 450-550° C. | 60 min- | 350-400° C. | gold | TF |
| | | 120 min | | | |

Although the invention has been described with reference to the above disclosure, it will be understood that modifications and variations are encompassed within the spirit and scope of the invention. Accordingly, the invention is limited only by the following claims.

We claim herein:

1. A set of hybrid austenite/martensite NiTi endodontic files, wherein for each file size in the set a customize heat-treatment is applied to each file after grinding a blank, which files in said set exhibit different levels of flexibility and torsional resistance depending on the sizes and exhibited colors of the resulting files, wherein said set is optionally configured to attach to an engine/motor driven device, and wherein color is indicative of degree of cyclic fatigue resistance, torsional resistance or both.

2. The set of austenite/martensite NiTi endodontic files of claim 1, wherein an exhibited color is gold.

3. The set of austenite/martensite NiTi endodontic files of claim 1, wherein said exhibited colors correspond to different levels of cyclic (flexural) fatigue resistance and/or torsional fatigue resistance, wherein the exhibited colors are selected from blue, purple or gold.

4. The set of austenite/martensite NiTi endodontic files of claim 3, wherein said levels of cyclic (flexural) fatigue resistance further depend on the size of the file.

5. The set of austenite/martensite NiTi endodontic files of claim 3, wherein the levels of torsional fatigue resistance further depend on the size of the file.

6. The set of austenite/martensite NiTi endodontic files of claim 3, wherein the colors and colors shades of the entire work part are purple, blue or gold.

7. The set of austenite/martensite NiTi endodontic files of claim 1, wherein the heat treatment comprises multiple variable heat-treatment techniques that decrease the percentage of superelasticity to control memory within a file as file size increases.

8. The set of austenite/martensite NiTi endodontic files of claim 1, wherein the heat treatment is applied after grinding the blank based on the final dimensions of the file.

9. A method of manufacturing a set of austenite/martensite NiTi endodontic files, comprising:
a) grinding one or more NiTi wires;
b) optionally shaping the one or more NiTi wires into a blade;
c) optionally grinding the proximal and distal tips of the bladed one or more NiTi wires;
d) cleaning the ground bladed one or more NiTi wires by ultrasonication;
e) heating the sonicated one or more NiTi wires;
f) cooling said heated one or more NiTi wires; and
g) assembling an endodontic file from the cooled one or more NiTi wires, wherein said endodontic file comprises a handle, smooth shaft and blade, wherein color of the resulting NiTi wire is indicative of degree of cyclic fatigue resistance, torsional fatigue resistance or both.

10. The method of claim 9, wherein the one or more NiTi wires have different diameters.

11. The method of claim 10, wherein the diameters are selected from the group consisting of about 0.8 mm, about 1.0 mm, and about 1.2 mm.

12. The method of claim 9, wherein the smooth shaft contains one or more measuring lines.

13. The method of claim 9, wherein the one or more sonicated NiTi wires are heated to between about 350° C. to about 550° C.

14. The method of claim 9, wherein the one or more sonicated NiTi wires are heated for between about 5 minutes to about 120 minutes, wherein sufficient oxidation occurs producing TiO, pure Ni and NiTi in a B2 phase on an external surface layer, and wherein, after oxidation, different phases are observed comprising TiO₂, Ni and Ni₃Ti beneath the Ni-rich Ni₃Ti layer.

15. A method of manufacturing a set of austenite/martensite NiTi endodontic files, comprising:
a) grinding one or more NiTi wires;
b) cleaning the ground one or more NiTi wires by ultrasonication;
c) heating the sonicated one or more NiTi wires to between about 350° C. to about 550° C. for a time sufficient to produce TiO, pure Ni and NiTi in a B2 phase on an external surface layer;
d) cooling said heated one or more NiTi wires; and
e) assembling an endodontic file from the cooled one or more NiTi wires, wherein said endodontic file comprises a handle, smooth shaft and blade, wherein the one or more NiTi wires have different diameters, and wherein color of the resulting NiTi wire is indicative of degree of cyclic fatigue resistance, torsional fatigue resistance or both.

16. The method of claim 15, wherein the diameters are selected from the group consisting of about 0.8 mm, about 1.0 mm, and about 1.2 mm.

17. The method of claim 15, wherein after oxidation, different phases are observed comprising TiO₂, Ni and Ni₃Ti beneath the Ni-rich Ni₃Ti layer.

18. The method of claim 15, wherein said files in said set exhibit different levels of flexibility and torsional resistance depending on the sizes and exhibited colors of the resulting files.

19. An endodontic device produced by the method of claim 9, wherein the exhibited colors are selected from gold, purple or blue.

20. An endodontic device produced by the method of claim 15, wherein the exhibited colors are selected from purple, blue or gold.
